(19) United States
(12) Patent Application Publication
(10) Pub. No.: US 2009/0213174 A1
(43) Pub. Date: Aug. 27, 2009

(54) LIQUID EJECTING APPARATUS

(75) Inventors: Shinichi Kamoshida, Shiojiri-shi (JP); Toshio Kumagai, Shiojiri-shi (JP); Norihiro Masuda, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/393,685

(22) Filed: Feb. 26, 2009

(30) Foreign Application Priority Data
Feb. 27, 2008 (JP) 2008-045613
Jan. 7, 2009 (JP) 2009-002003

(51) Int. Cl. B41J 2/165

(52) U.S. Cl. 347/33

(57) ABSTRACT

A liquid ejecting apparatus including an ejection head capable of ejecting liquid that may be cured by irradiation of an energy ray, a wiping member that is capable of wiping a nozzle forming face of the ejection head, an irradiation unit that is capable of curing and solidifying the liquid adhering to the wiping member by irradiating the energy ray after the nozzle forming face is wiped by the wiping member, and a removal unit that removes the solidified liquid from the wiping member.

### BACKGROUND OF THE INVENTION

The entire disclosure of Japanese Patent Application Nos. 2008-045613, filed Feb. 27, 2008 and 2009-002003, filed Jan. 7, 2009 are expressly incorporated herein by reference.

1. Technical Field

The present invention relates to a liquid ejecting apparatus capable of ejecting energy ray-curable liquid such as energy ray-curable ink, which is cured by irradiation of an energy ray such as an ultraviolet (UV) ray. More particularly, the present invention relates to a liquid ejecting apparatus such as an ink jet recording apparatus that is capable of forming liquid dots on a recording medium by ejecting ink droplets from a nozzle in accordance with print data.

2. Related Art

One example of a liquid ejecting apparatuses capable of ejecting liquid onto a target that is currently known in the art is a ink jet recording apparatuses that performs a printing operation by ejecting ink onto a recording sheet. A recording head of the ink jet recording apparatus performs a printing operation by discharging ink, which is pressed by a pressure generating chamber, from a nozzle towards a recording sheet as ink droplets. One problem with the apparatuses currently known in the art, however, is that the recording head may defectively discharge the ink during the printing operation due to an increase in the viscosity of ink, which is caused by evaporation of a solvent from a nozzle opening, solidification of ink adhering to near the nozzle, or the like. Thus, in the ink jet recording apparatus, a cleaning operation for cleaning the nozzle forming face by wiping the nozzle forming face is performed in order to maintain desirable discharge characteristics.

One example of a ink jet recording apparatus, disclosed in Japanese Application No. JP-A-10-175292, comprises an ink jet recording apparatus including a rotary drum that can hold a printing medium on an outer circumference thereof and a recording head that is disposed near the rotary drum. The recording head discharges ink toward the printing medium that is held on the outer circumference. The recording head also has a wiping member, which removes any residual ink adhering to a nozzle forming face of the recording head by coming into contact with the nozzle forming face of the recording head in accordance with rotation of the rotary drum. The wiping member is installed on the outer circumference of the rotary drum.

In addition to traditional liquid apparatuses, there are UV ink jet apparatuses. These UV ink jet apparatuses perform printing operations by curing energy ray-curable ink using the irradiation of an energy ray such as an ultraviolet (UV) ray after the UV ink has been adhered to a recording medium.

One difficulty in properly cleaning a recording head in a recording apparatus that uses energy ray-curable ink, however, is that the ink on the recording head may be cured and hardened onto the wiping member. Thus, the wiping operation may be inadequate and damage to the nozzle forming face of the recording head may be generated.

### BRIEF SUMMARY OF THE INVENTION

An advantage of some aspects of the invention is that it provides a liquid ejecting apparatus capable of maintaining wiping capability by removing liquid adhering to the wiping member assuredly.

According to a first aspect of the invention, there is provided a liquid ejecting apparatus including: an ejection head capable of ejecting liquid that may be cured by irradiation of an energy ray, a wiping member that is capable of wiping a nozzle forming face of the ejection head, an irradiation unit that is capable of curing and solidifying the liquid adhering to the wiping member by irradiating the energy ray after the nozzle forming face is wiped by the wiping member, and a removal unit that removes the solidified liquid from the wiping member.

In the above-described liquid ejecting apparatus, after the nozzle forming face of the ejection head is wiped by using the wiping member, an energy ray is irradiated for the liquid adhering to the wiping member so as to solidify the liquid, after which the solidified liquid is removed from the wiping member. As described above, by performing wiping, solidification of liquid by irradiation, and removal of the solidified liquid, the liquid adhering to the wiping member is removed assuredly. Accordingly, the wiping capability is maintained, and defective wiping and damage of the nozzle forming face are prevented. In addition, the adhering solidified liquid after each wiping operation is removed assuredly by aggressively curing the energy ray-curable liquid that adheres to the wiping member by irradiation of an energy ray. Accordingly, cleaning of the nozzle forming face can be achieved over a long period of time, and thereby stabilization of ejection characteristics can be achieved.

### BRIEF DESCRIPTION OF THE DRAWINGS

The invention will be described with reference to the accompanying drawings, wherein like numbers reference like elements.

FIG. 1 is a perspective view showing a schematic configuration of a recording apparatus according to an embodiment of the invention;

FIG. 2 is a cross-section view showing major parts of a liquid ejecting apparatus according to an embodiment of the invention;

FIG. 3 is a cross-section view of major parts according to a second embodiment of the invention;

FIGS. 4A-4C are diagrams showing an example of a third embodiment of the invention;

FIG. 5A is a diagram showing the positional relationship of an ejection head 1 and the irradiation unit 3 with respect to a rotary drum 20;

FIGS. 5B and 5C are explanatory diagrams for the protrusion height of a wiping member 2 corresponding to distances ds and dn shown in FIG. 5A;

FIGS. 6A and 6B are diagrams showing a first modified example of the third embodiment;

FIGS. 7A and 7B are diagrams showing a second modified example of the third embodiment;

FIG. 8 is a cross-section view of major parts according to a third modified example of the third embodiment; and

FIGS. 9A-9D are diagrams showing a fourth embodiment of the invention.

### DESCRIPTION OF EXEMPLARY EMBODIMENTS

Next, embodiments of the invention will be described in detail.

Hereinafter, an ink jet recording apparatus will be described as an exemplary liquid ejecting apparatus according to an embodiment of the invention capable of performing aspects of the invention. The ink jet recording apparatus will be described with reference to the accompanying drawings.

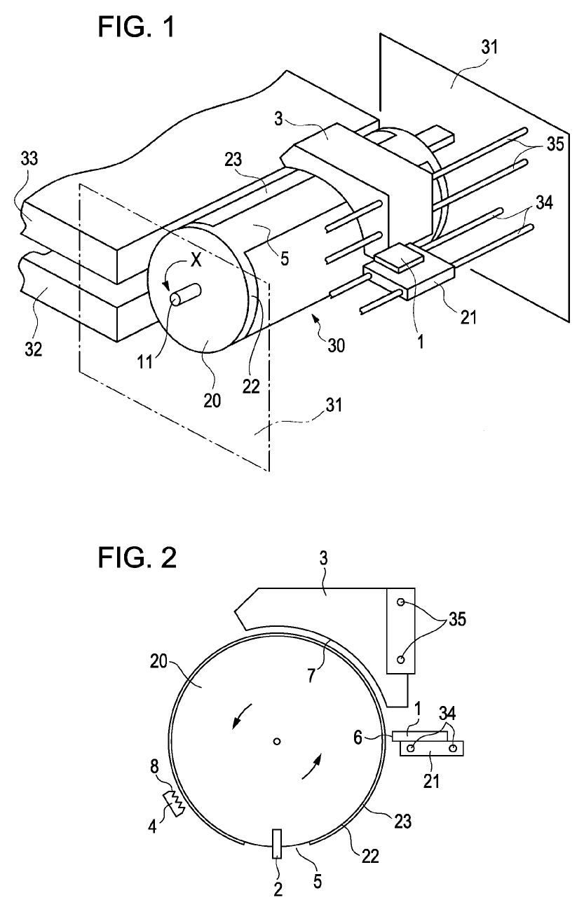

FIG. 1 shows the configuration of major parts of an ink jet recording apparatus.

The ink jet recording apparatus includes a rotary drum 20 that supports a recording sheet 23 as a recording medium on the outer circumference 22 thereof. The circumferential face 22 comprises a support face and rotates about a shaft center. The ink jet recording apparatus further includes an ejection head 1 that is mounted on a carriage 21 which reciprocates along the outer circumference 22 in a direction perpendicular to the rotation direction of the rotary drum 20 and ejects an energy ray-curable liquid from a nozzle toward the recording sheet 23 that is supported on the outer circumference 22. The ink jet recording apparatus also includes an irradiation unit 3 that irradiates an energy ray in order to adhere energy ray-curable liquid ejected from the ejection head 1 to the recording sheet 23.

More specifically, in the ink jet recording apparatus, a recording unit 30 is disposed between one pair of frames 31 that are erected to face each other, a recording sheet 23 is fed from a paper feed unit 32 to the recording unit 30 so as to be recorded. Then, after the recording process is completed, the recording sheet 23 for which the recording process is discharged to a paper discharge unit 33.

The recording unit 30 is configured to include the rotary drum 20 that is supported between one pair of the frames 31 that are disposed parallel to each other, one pair of first guide shafts 34 and one pair of second guide shafts 35 that are preferably the same size as the first guide shafts 34, the carriage 21 that is guided by the first guide shafts 34 and reciprocates along the rotary drum 20, the ejection head 1 that is mounted on the carriage 21, and the irradiation unit 3 that is guided by the second guide shafts 35 and reciprocates along the rotary drum 20.

The ejection head 1 that is mounted on the carriage 21 discharges ink, which adheres to the recording sheet 23 as the recording sheet 23 rotates and is supported by the rotary drum 20. In this example, an energy ray-curable liquid such as an energy ray-curable ink that is cured by irradiation of an energy ray represented by light such as ultraviolet (UV) is used as the above-described ink. For example, the energy ray-curable liquid is ultraviolet-curable ink. In particular, the ultraviolet-curable ink, for example, may be formed of components such as an ultraviolet-curable resin, a pigment, additives for performing a stable printing process by ink jet, and water.

The rotary drum 20 is rotated in the direction of an arrow shown in the figure while the ultraviolet-curable ink is ejected to the recording sheet 23, Meanwhile, an ultraviolet ray is irradiated from the irradiation unit 3 to the ultraviolet-curable ink that is adhered to the recording sheet 23. Accordingly, an image that is formed by the ultraviolet-curable ink is fixed to the surface of the recording sheet 23.

Then, when an image is recorded in a portion of the paper 23 in the longitudinal direction of the rotary drum 20 by rotating the rotary drum 20 one or more times, the carriage 21 moves along the first guide shaft 34 and performs a same recording operation for an area adjacent to the recorded portion of the paper 23. Thereafter, the image can be formed on the entire surface of the recording sheet 23 by repeating the operation for moving the carriage 21 for each time the rotary drum 20 completes a rotation while the ejection head 1 performs the recording operation.

FIG. 2 is a cross-section view showing major parts of the liquid ejecting apparatus according to this embodiment.

The liquid ejecting apparatus includes the ejection head 1 which is capable of ejecting liquid that is cured by irradiation of an energy ray, a wiping member 2 that wipes a nozzle forming face 6 of the ejection head 1, the irradiation unit 3 that serves as an irradiation member that solidifies the liquid adhering to the wiping member 2 after the above-described wiping operation by irradiating an energy ray, and a removal unit 4 that removes the solidified liquid that is solidified after the irradiation from the wiping member 2.

The wiping member 2 is disposed beyond the ends of the recording sheet 23 that is held around the outer circumference 22 of the rotary drum 20. Hereinafter, this area beyond the ends of the recording sheet 23 where there is no paper disposed on the outer circumference 22 is referred to as the non-paper area 5. The wiping member 2 is acquired by forming an elastic member such as rubber, elastomer, or polyurethane in a blade shape. In addition, the wiping member 2 is disposed so as to protrude in an approximate radial pattern from the outer circumference 22 of the rotary drum 20. The wiping member 2 is configured such that the wiping member 2 is brought into contact with the nozzle forming face 6 facing the outer circumference 22 of the rotary drum 20 of the ejection head 1 in order to cast aside and remove any residual ink adhering to the nozzle forming face 6 by performing a wiping operation by rotating the rotary drum 20.

The irradiation unit 3 irradiates an energy ray to ink adhering to the wiping member 2 after the wiping operation is performed in order to solidify the ink ejected from the ejection head 1 to the recording sheet 23.

When the wiping member 2 moves along the circumference of the rotary drum 20 drum by rotating the rotary drum 20, the front end part of the wiping member 2 is brought into contact with the removal unit 4, and thereby the removal unit 4 removes the solidified liquid. In this example, a concavo-convex face 8 is formed in a part of the removal unit 4 that faces the outer circumference 22 of the rotary drum 20. Thus, the concavo-convex face 8 is brought into contact with the wiping member 2 that moves along the outer circumference 22 by rotating the rotary drum 20. Accordingly, the solidified liquid is scraped and removed from the wiping member 2.

In this example, the ejection head 1, the irradiation unit 3, and the removal unit 4 are sequentially disposed along the rotation direction of the rotary drum 20 so as to follow the outer circumference 22 of the rotary drum 20.

Under such a configuration, in the liquid ejecting apparatus described above, when the ultraviolet curable ink is ejected from the ejection head 1 to the recording sheet 23 while the rotary drum 20 rotates, the ejection process stops when the non-paper area 5 of the recording sheet 23 faces the nozzle forming face 6 of the ejection head 1. Then, by continuing the rotation of the rotary drum 20, the wiping member 2 wipes the nozzle forming face 6 of the ejection head 1.

When the rotary drum 20 rotates further, the wiping member 2 faces a light emitting face 7 of the irradiation unit 3 that faces the outer circumference 22 of the rotary drum 20 so as to receive irradiation of ultraviolet rays. Accordingly, the ultraviolet-curable ink that is adhered to the wiping member 2 by the wiping operation is solidified.

Then, the rotary drum 20 rotates further, and the wiping member 2 is moved away from the irradiation unit 3 and is brought into contact with the concave-convex face 8 of the removal unit 4. Accordingly, the solidified liquid is scraped and removed, the process proceeds to the next wiping operation.

At this moment, in a case where the rotary drum 20 is configured to be able to rotate in the reverse direction, the solidified liquid adhering to both faces of the wiping member 2 can be removed by reversely rotating the rotary drum 20 so as to bring the removal unit 4 and the wiping member 2 into contact with each other repeatedly in both the clockwise and counterclockwise direction.

As described above, according to this embodiment, after the nozzle forming face 6 of the ejection head 1 is wiped by the wiping member 2, the ink adhering to the wiping member 2 is solidified by irradiating an energy ray, and the solidified liquid that is solidified by the irradiation is removed from the wiping member 2. As described above, by performing a wiping operation, solidification of ink by irradiation, and removal of the solidified ink in a series, the ink adhering to the wiping member 2 can be reliably be removed. Accordingly, by maintaining the wiping capability, it is possible to prevent defective wiping and damage of the nozzle forming face 6. In addition, the energy ray-curable ink adhering to the wiping member 2 is cured aggressively by irradiation of an energy ray, and the solidified liquid may be removed assuredly after each wiping operation. Accordingly, it is possible to reliably clean a nozzle forming face 6 over a long period of time, and thereby stabilization of ejection characteristics can be achieved.

In addition, the wiping member 2 is disposed between end parts of the recording sheet 23 that is held on the rotary drum 20, and the ejection head 1, the irradiation unit 3, and the removal unit 4 are disposed along the outer circumference 22 of the rotary drum 20. Accordingly, the wiping operation, solidification of the liquid by irradiation, and removal of the solidified liquid are performed in a series in accordance with the rotation of the rotary drum 20. In addition, by disposing the wiping member 2 in a space between the recording sheet 23, a space saving and simplified structure can be achieved. In addition, a regular wiping operation can be performed easily and assuredly, and the next wiping operation may be performed after the ink is solidified and removed from the previous wiping operation. Accordingly, it is possible to consistently clean the nozzle forming face 6, even when it has been a long period of time since the previous wiping operation, and thereby stabilization of ejection characteristics can be achieved.

In addition, since the removal unit 4 removes the solidified liquid by being brought into contact with the wiping member 2, solidified liquid that is solidified by the irradiation of an energy ray for each wiping operation can be assuredly removed. Thereby, cleaning of the nozzle forming face 6 that has been dormant for a long time can be achieved, and accordingly, stabilization of ejection characteristics can be achieved.

In addition, a commonly used irradiation unit 3 that solidifies the ink ejected from the ejection head 1 to the recording sheet 23 may be used as the above-described irradiation unit 3. Accordingly, the ink adhering to the wiping member 2 is solidified by using the irradiation unit 3 that solidifies the ink ejected from the ejection head 1 to the recording sheet 23, and thereby a specific configuration irradiation unit 3 is not necessary. Accordingly, space saving and low cost can be achieved.

In addition, by configuring the rotary drum 20 to be rotatable in both the forward and reverse direction, any solidified liquid that adheres to both sides of the wiping member 2 can be removed by the removal unit 4. Accordingly, the solidified liquid that adheres to the wiping member 2 is reliably removed, and thus it is possible to continually ensure a clean nozzle forming face 6. Therefore, stabilization of ejection characteristics can be achieved.

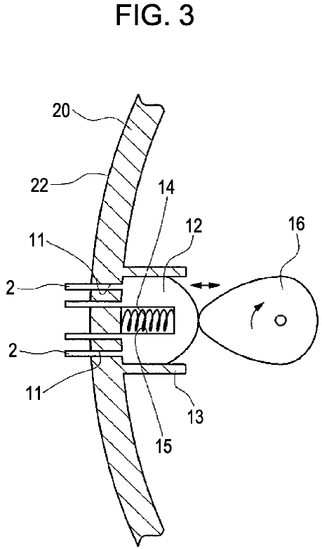

FIG. 3 is a cross-section view of major parts according to a second embodiment of the invention.

According to this embodiment, the protrusion height of the wiping member 2 can be changed, and the wiping member 2 is configured to be able to move forward or backward with respect to the outer circumference 22 of the rotary drum 20.

In this example, a plurality of wiping members 2 are used. In the example shown in FIG. 3, four wiping members 2 are used. In addition, the rotary drum 20 is hollow, such that a plurality of through holes 11 having a slit shape through which the wiping members 2 are inserted and pass the peripheral wall is formed. According to this example, the plurality of the wiping members 2 formed in a blade shape are formed so as to protrude from a base material part 12. Accordingly, the wiping members 2 pass through the through holes 11 from the rear side of the peripheral wall of the rotary drum 20.

The base material part 12 is capable of moving by a holding part 13 and can be pressed by a cam member 16 from the rear side. In addition, inside a storage space 15 located inside the base material part 12, a biasing member 14 such as a spring is housed so as to bias the base material part 12 toward the cam member 16 in a pressing manner. Accordingly, by driving the cam member 16 to rotate by a driving unit not shown in the figure, the base material part 12 moves forward or backward with respect to the peripheral wall of the rotary drum 20. Thereby, the protrusion height of the wiping member 2 from the outer circumference 22 can be changed, and the wiping member 2 is configured to be movable forward or backward with respect to the outer circumference 22 of the rotary drum 20.

According to this embodiment, by creating a protrusion height of the wiping member 2 from the outer circumference 22 that is capable of varying, the wiping member 2 and the ejection head 1 may engage with each other, while the irradiation unit 3 and the wiping member 2 may not engage with each other. Accordingly, by configuring the protrusion height of the wiping member 2 to be changeable, a wiping operation can be performed assuredly, and damage and contamination of the irradiation unit 3 can be prevented.

In addition, since the wiping member 2 can move forward or backward with respect to the outer circumference 22 of the rotary drum 20, the wiping member 2 may be moved forward from the outer circumference 22 of the rotary drum 20 at a time when the wiping operation is performed, and the solidified ink adhering to the wiping member 2 can be removed when the rotary drum is moved backward. Accordingly, the wiping operation may be performed, and the solidified liquid adhering to the wiping member 2 may be removed. Thus, cleaning of the nozzle forming face 6 that is dormant for a long time is implemented, and thereby stabilization of ejection characteristics can be achieved.

Other configurations are the same as those of the above-described embodiment (hereinafter, also referred to as a first embodiment), with like components having the same reference number. Also in this embodiment, the same advantages as those of the above-described embodiment (first embodiment) are acquired.

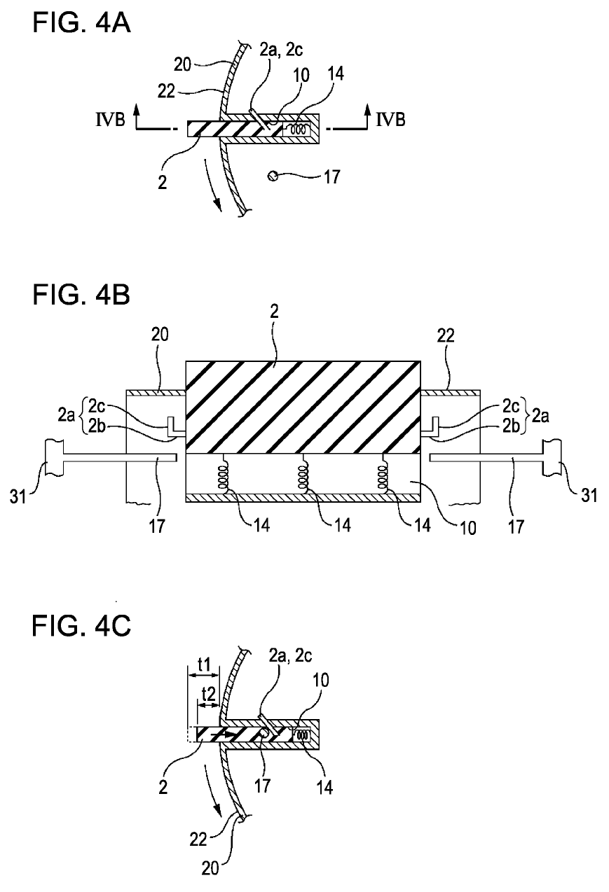

FIG. 4A is a cross-section view of major parts of a third embodiment of the invention.

In this embodiment, as in the second embodiment, the protrusion height of the wiping member 2 can vary, and the wiping member 2 is configured to be movable forward or backward with respect to the outer circumference 22 of the rotary drum 20. In the third embodiment, the wiping member 2 is configured to be engaged with both the ejection head 1 and the irradiation unit 3, as described more fully below. Accordingly, it is possible to implement not only cleaning of the nozzle forming face 6 but also cleaning of the light emitting face 7 of the irradiation unit 3. Described in detail, any ink mist that is generated at a time when ink is ejected may adhere to the light emitting face 7 of the irradiation unit 3. Accordingly, the wiping member 2 wipes the light emitting face 7 also, and thereby contamination of the light emitting face 7 is prevented. Therefore, stabilization of the light emitting characteristics can be achieved.

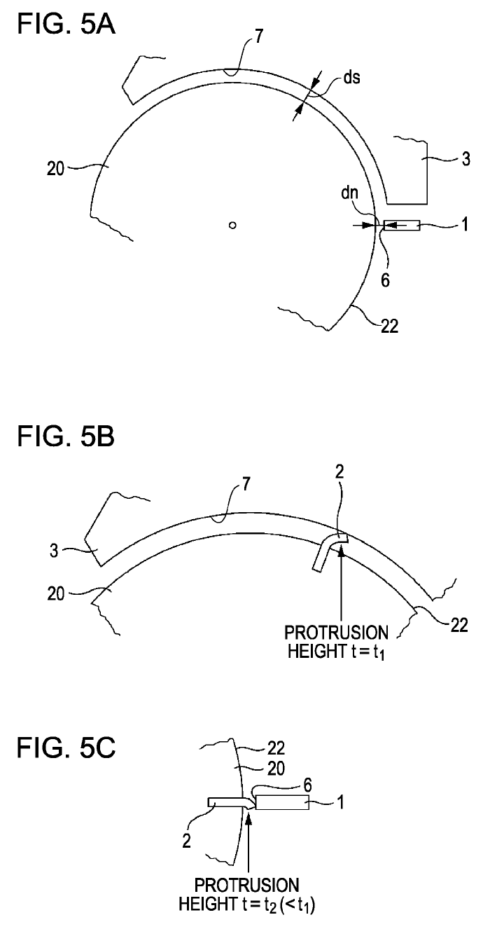

In addition, according to this embodiment, as shown in FIG. 5A, a distance (hereinafter, referred to as a distance dn) between the ejection head 1 (in particular, the nozzle forming face 6) and the outer circumference 22 of the rotary drum 20 is shorter than a distance (hereinafter, referred to as a distance ds) between the irradiation unit 3 (in particular, the light emitting face 7) and the outer circumference 22 of the rotary drum 20. In other words, according to this embodiment, there is a difference between the distance ds and the distance dn. FIG. 5A is a diagram showing the positional relationship of the ejection head 1 and the irradiation unit 3 with respect to the rotary drum 20.

Thus, according to the third embodiment, when the wiping member 2 is engaged with the ejection head 1, the protrusion height becomes a height corresponding to the distance dn. Subsequently, when the wiping member 2 is engaged with the irradiation unit 3, the protrusion height becomes a height corresponding to the distance ds. In other words, according to this embodiment, the protrusion height is adjusted in correspondence with the distance ds and the distance dn. Thus, when the wiping member 2 is to be engaged with the irradiation unit 3, the protrusion height becomes a height t1 corresponding to the distance dn. This protrusion height t1, as shown in FIG. 5B, is a height that is appropriate for the wiping member 2 to be brought into contact with the light emitting face 7 of the irradiation unit 3. On the other hand, when the wiping member 2 is to be engaged with the ejection head 1, the protrusion height becomes a height t2 corresponding to the distance ds. This protrusion height t2, as shown in FIG. 5C, is a height that is appropriate for the wiping member 2 to be brought into contact with the nozzle forming face 6 of the ejection head 1. This protrusion height t2 is shorter than the protrusion height t1. FIGS. 5B and 5C are explanatory diagrams for the protrusion height of the wiping member 2 corresponding to the distance ds (and the distance dn).

As a result, according to the third embodiment, the wiping member 2 can be brought into contact with the ejection head 1 and the irradiation unit 3 with an appropriate contact pressure. Accordingly, a wiping operation can be performed without incurring any damage to the ejection head 1 or the irradiation unit 3. Hereinafter, a detailed example of the configuration according to the third embodiment will be described with reference to FIGS. 4A-4C. FIG. 4B is a cross-section view taken along line IVB-IVB shown in FIG. 4A. FIG. 4C is a diagram showing the appearance of the changing or decreasing protrusion height.

In this example, the rotary drum 20 is formed to have a hollow center, and side ends of the rotary drum 20 are open. In addition, in the peripheral wall of the rotary drum 20, a depressed area 10 is formed where the wiping member 2 is disposed. Into this depressed area 10, the wiping member 2 is retractable, and a part of the wiping member 2 protrudes to the outer side of the outer circumference 22 of the rotary drum 20. In addition, on the bottom of the depressed area 10, a biasing member 14 such as a spring is seated. This biasing member 14 presses the wiping member 2 that is intruded into the depressed area 10 to the outer side in the diameter direction of the rotary drum 20.

In addition, side ends of the depressed area 10 are open, and “L”-shaped parts 2a are disposed on sides of the side ends, as shown FIG. 4B. These “L”-shaped parts 2a are installed in both ends of the wiping member 2. When the rotary drum 20 rotates, the “L”-shaped parts 2a rotate integrally with the wiping member 2. In addition, the “L”-shaped parts 2a are formed of a pull-out part 2b that overhangs to the outer side in the shaft direction of the rotary drum 20 and a crossing part 2c that intersects the pull-out part 2b (see FIG. 4B). In addition, the crossing part 2c is angled such that the upper end of the crossing part 2c is pointed toward a direction opposite to the rotation direction of the rotary drum 20 (see FIG. 4A).

In addition, pressing parts 17 that extend toward both ends in the shaft direction of the rotary drum 20 are fixed to the main body of the printer, and the front end parts of the pressing parts 17 are disposed inside both ends of the rotary drum 20. Here, the main body of the printer is a part (for example, a frame 31) which is formed separate from the rotary drum 20. In other words, the rotary drum 20 rotates relative to the pressing parts 17. By relatively rotating the rotary drum 20, the pressing parts 17 are engaged with the crossing parts 2c. In addition, during rotation of the rotary drum 20, the pressing parts 17 are engaged only with the crossing parts 2c, and the pressing parts 17 are not engaged with other members located inside the rotary drum 20.

Then, when the rotary drum 20 rotates so that the pressing parts 17 and the crossing parts 2c are engaged with each other, the pressing parts 17 press the wiping member 2 to the inner side in the diameter direction of the rotary drum 20 through the “L”-shaped parts 2a. Accordingly, the wiping member 2 is moved backward to the inside of the rotary drum 20, and thus, the protrusion height decreases. More specifically, as shown in FIG. 4C, as the pressing parts 17 are engaged with the crossing parts 2c and press the wiping member 2 as described above, the protrusion height of the wiping member 2 changes from t1 to t2. In other words, according to the third embodiment, the protrusion height of the wiping member 2 changes between t1 and t2.

Under the configuration described above, by moving the wiping member 2 forward or backward relative to the peripheral wall of the rotary drum 20 by using rotation of the rotary drum 20, the protrusion height of the wiping member 2 can be changed. In particular, according to this embodiment, it is configured that the wiping member 2 is pressed by the biasing member 14 so as to maintain the protrusion height to t1 so long as the wiping member 2 is not engaged with the ejection head 1. Such a configuration is implemented by locating the pressing parts 17 in positions which do not engage with the crossing parts 2c of the “L”-shaped parts 2a in the rotation direction of the rotary drum 20 except for the time when the wiping member 2 is engaged with the ejection head 1. When engaged with the irradiation unit 3, the wiping member 2 wipes the irradiation unit 3 with the protrusion height t1 corresponding to the distance ds.

On the other hand, when the wiping member 2 is engaged with the ejection head 1 during rotation of the rotary drum 20, the wiping member 2 is pressed by the pressing parts 17 in resistance against biasing of the biasing members 14, and the protrusion height changes from t1 to t2. Such a configuration is implemented with the pressing parts 17 reaching positions for engagement with the crossing parts 2c of the “L”-shaped parts 2a in the rotation direction of the rotary drum 20 when the wiping member 2 is engaged with the ejection head 1. Then, when engaged with the ejection head 1, the wiping member 2 wipes the irradiation unit 3 by being brought into contact with the nozzle forming face 6 at the protrusion height t2 corresponding to the distance dn.

As a result, it is possible to prevent applying an excessive contact force to the ejection head 1 when wiping the ejection head 1 by using the wiping member 2, while maintaining a protrusion height that is appropriate for wiping the irradiation unit 3.

As described above, according to the third embodiment, by adjusting the protrusion height of the wiping member 2 in accordance with a distance between a device (the ejection head 1 and the irradiation unit 3) to be wiped by the wiping member 2 and the outer circumference 22 of the rotary drum 20, the wiping operation for the device to be wiped can be performed appropriately. Other configurations are the same as those of the embodiment (that is, the first embodiment) shown in FIG. 2, and thus, a same reference sign is assigned to each same part. In addition, the same advantages as those of the first embodiment are acquired from the third embodiment.

The configuration for adjusting the protrusion height in accordance with the distance between the device to be wiped and the outer circumference 22 of the rotary drum 20 is not limited to the above-described configuration. Thus, a different configuration may be employed as the above-described configuration. Hereinafter, several different configurations will be described as examples of variations that may be made without departing from the meaning or scope of the invention.

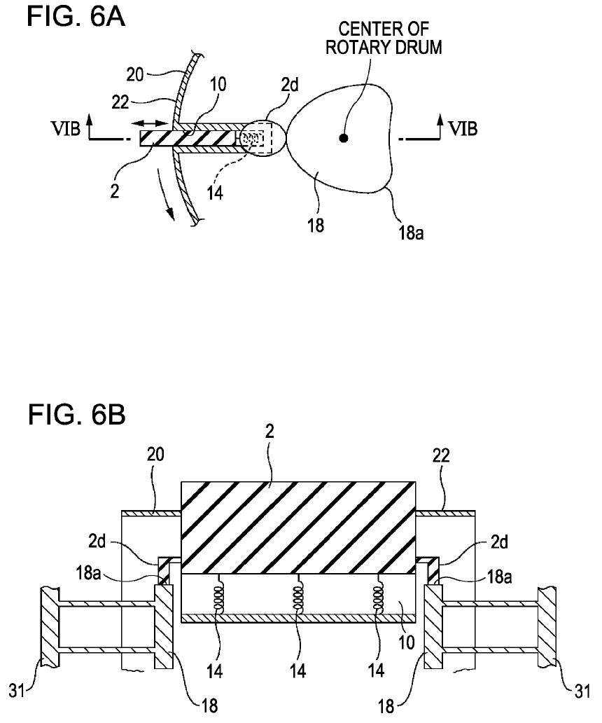

FIG. 6A is a cross-section view of major parts showing a first modified example of the third embodiment. FIG. 6B is a cross-section view taken along line VIB-VIB shown in FIG. 6A.

In this example, in order to adjust the protrusion height of the wiping member 2 by using rotation of the rotary drum 20, a cam 18 having an approximately heart-shape is contained inside the rotary drum 20, and a contact 2d that is brought into contact with a cam face 18a of the cam 18 which is sled on the cam face 18a is attached to the wiping member 2. The cam 18 is fixed to the main body (in particular, a frame 31) of the printer such that the center of the cam 18 coincides with the rotation center of the rotary drum 20. Accordingly, the rotary drum 20 rotates relative to the cam 18.

The wiping member 2 protrudes from the inner side of the rotary drum 20 toward the outer side thereof through a through hole 11 that is formed on the peripheral wall of the rotary drum 20. In addition, the wiping member 2 is biased by the biasing members 14 such that contact between the contact 2d and the cam face 18a is maintained. Then, when the rotary drum 20 rotates relative to the cam 18, the wiping member 2 and the contact 2d rotate relative to the cam 18 as well. During this time, since the contact 2d is sled on the cam face 18a, the wiping member 2 moves in the diameter direction of the rotary drum 20, and thereby the protrusion height of the wiping member 2 changes. In addition, the cam face 18a is formed in a shape for which the protrusion height changes between t1 and t2.

Under the above-described configuration, also in this example, the wiping member 2 is engaged with both the ejection head 1 and the irradiation unit 3. Accordingly, the protrusion height becomes t1 for a case where the wiping member 2 is engaged with the irradiation unit 3. On the other hand, the protrusion height becomes t2 for a case where the wiping member 2 is engaged with the ejection head 1. In other words, according to the configuration of the first modified example, the protrusion height can be adjusted in accordance with a distance between a device to be wiped and the outer circumference 22 of the rotary drum 20 by using rotation of the rotary drum 20.

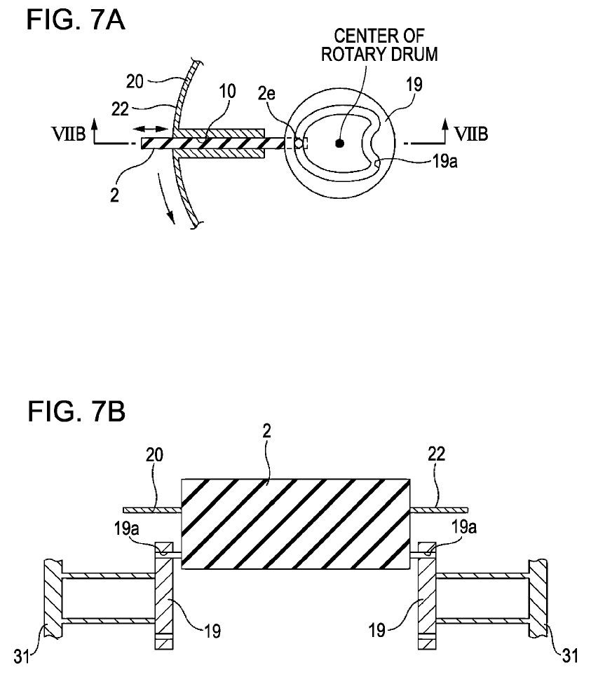

FIG. 7A is a cross-section view of major parts showing a second modified example of the third embodiment. FIG. 7B is a cross-section view taken along line VIIB-VIIB shown in FIG. 7A.

In this example, a groove cam 19 that has a same function as that of the cam 18 according to the first modified example is contained inside the rotary drum 20. An engagement protrusion 2e attached to the wiping member 2 is engaged with a groove 19a formed in the groove cam 19 moves along the groove 19a. Since the groove cam 19 is fixed to the main body of the printer such that the center of the groove cam 19 coincides with the rotation center of the rotary drum 20, the rotary drum 20 rotates relative to the groove cam 19.

Then, when the rotary drum 20 rotates relative to the groove cam 19, the engagement protrusion 2e moves along the groove 19a. As a result, the wiping member 2 moves in the diameter direction of the rotary drum 20, and the protrusion height of the wiping member 2 is changed. In addition, the groove 19a is formed in a shape for which the protrusion height changes between t1 and t2. This configuration offers the same advantages as those of the previously described examples.

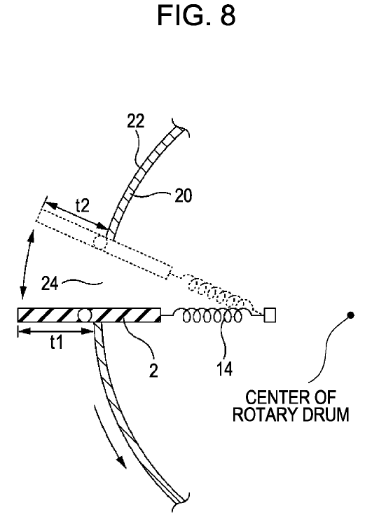

FIG. 8 is a cross-section view of major parts showing a third modified example of the third embodiment.

In this example, an opening 24 having a width that increases slightly in the circumferential direction of the rotary drum 20 is formed on the peripheral wall of the rotary drum 20. The wiping member 2 protrudes from the inner side of the rotary drum 20 toward the outside through the opening 24. In addition, protrusions 2f that extend from both side ends of the wiping member 2 toward the outer side in the shaft direction of the rotary drum 20 are formed in a part of the wiping member 2 that is located on the outside of the rotary drum 20.

In addition, the wiping member 2 is pressed toward the outside of the rotary drum 20 by the basing member 14. The wiping member 2 can be oscillated so as to be moved in a direction opposite to the rotation direction of the rotary drum 20 with an opposite corner that is located on a side opposite to a side of the biasing member 14, which is fixed to the wiping member 2 of the basing member 14, which is used as a fulcrum point (see FIG. 8). In addition, the opposite corner is positioned to be disposed slightly toward the wiping member 2 from the rotation center of the rotary drum 20.

When the wiping member 2 is engaged with the ejection head 1 during rotation of the rotary drum 20, the protrusion 2f attached to the wiping member 2 is engaged with another pressing part (not shown) that is fixed to the main body (for example, a side of the ejection head 1) of the printer. In such a state, when the rotary drum 20 rotates further, the pressing part presses the wiping member 2 such that the wiping member 2 is moves in a direction opposite to the rotation direction of the rotary drum 20. Accordingly, the wiping member 2 that is located in a normal position (a position denoted by a solid line shown in FIG. 8) in the rotation direction of the rotary drum 20 is moved to a pivoted position (denoted by the dotted line shown in FIG. 8). In accordance with the above-described operation, the protrusion height of the wiping member 2 changes from t1 to t2.

Using this configuration, so long as the wiping member 2 is not engaged with the ejection head 1, the wiping member 2 is biased by the biasing member 14, and the protrusion height can be maintained at t1. Accordingly, when the wiping member 2 is engaged with the irradiation unit 3, the protrusion height becomes t1. On the other hand, when the wiping member 2 is engaged with the ejection head 1, the wiping member 2 is pressed by another pressing part so as to move in the direction opposite to the rotation direction of the rotary drum 20, and whereby the protrusion height changes from t1 to t2.

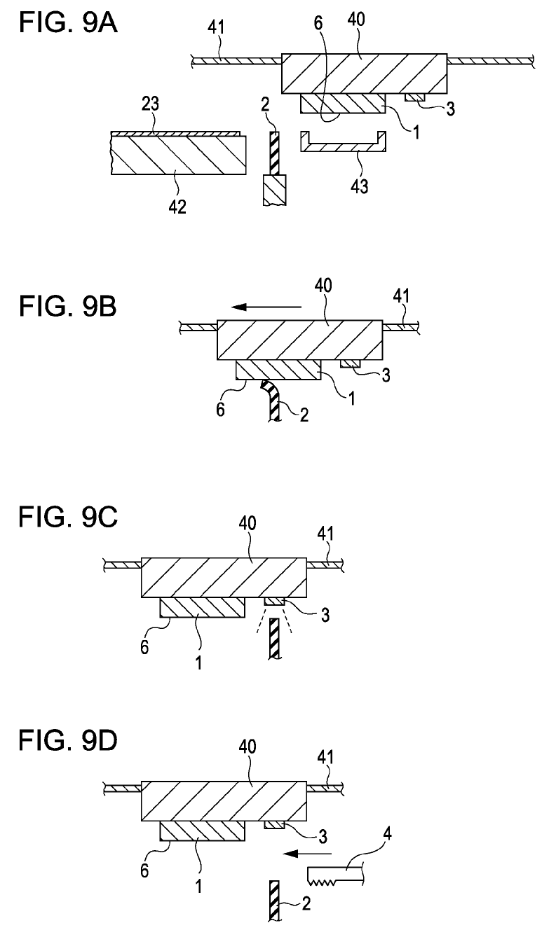

FIGS. 9A-9D are diagrams showing a fourth embodiment of the invention.

An apparatus of this example includes a platen 42 that holds a recording sheet 23 and a carriage 40 that is guided by a guide bar 41 disposed along the platen 42 which reciprocates the ejection head 1. The irradiation unit 3 that irradiates an energy ray to the ejected ink is disposed in the carriage 40. In addition, a capping member 43 that caps the nozzle forming face 6 of the ejection head 1 and the wiping member 2 are disposed in a waiting position of the ejection head 1.

During a recording operation, the irradiation unit 3 irradiates an energy ray by ejecting ink from the ejection head 1 in a record area that is positioned on the recording sheet 23.

As shown in FIG. 9B, during a wiping process, a wiping operation is performed by moving the ejection head 1 in a state in which the wiping member 2 is elevated until the front end of the wiping member 2 is brought into contact with the nozzle forming face 6 of the ejection head 1. Next, as shown in FIG. 9C, the irradiation unit 3 moves the carriage 40 to a position in which the irradiation unit 3 faces the wiping member 2 and performs irradiation of an energy ray, and whereby the adhering ink is solidified. Thereafter, as shown in FIG. 9D, the wiping member 2 is lowered, and scraping the solidified liquid by using the removal unit 4 is performed.

In addition, in the above-described embodiments, the irradiation unit 3, for example, may be an LED that emits light of an ultraviolet band. However, the irradiation unit 3 is not limited thereto. Thus, various energy ray irradiating units such as a metal halide lamp, a xenon lamp, a carbon-arc lamp, a chemical lamp, a low-pressure mercury lamp, or a high-pressure mercury lamp may be used as the above-described irradiation unit 3.

In the above-described embodiments, the ejection head 1 may be applied to a liquid ejecting apparatus that uses a piezoelectric vibrator as a pressure generating element that is a drive element for ejecting liquid. In addition, the ejection head 1 may be applied to a liquid ejecting apparatus that uses a heating element.

In addition, although an ink jet recording apparatus was used as an example of a liquid ejecting apparatus of the invention, the invention may be applied to various liquid ejecting apparatuses such as an apparatus having a coloring material ejecting head that is used for manufacturing a color filter or a liquid crystal display, an apparatus having an electrode material (conductive paste) ejecting head that is used for forming an electrode of an organic EL display, a field emission display (FED), or the like, an apparatus having a bioorganic material ejecting head that is used for manufacturing a bio chip, and an apparatus having a test material ejecting head as a precision pipette. Thus, various liquid ejecting apparatuses may be used without departing from the meaning or scope of the invention.

What is claimed is:

1. A liquid ejecting apparatus comprising:
an ejection head capable of ejecting liquid that may be cured by irradiation of an energy ray;
a wiping member that is capable of wiping a nozzle forming face of the ejection head;
an irradiation unit that is capable of curing and solidifying the liquid adhering to the wiping member by irradiating the energy ray after the nozzle forming face is wiped by the wiping member; and
a removal unit that removes the solidified liquid from the wiping member.

2. The liquid ejecting apparatus according to claim 1, further comprising a rotary drum that is capable of rotating about a shaft center and holding a recording medium held on an outer circumference of the rotary drum,
wherein the wiping member is disposed in a space between the ends of the recording medium held by the rotary drum, and
wherein the ejection head, the irradiation unit, and the removal unit are disposed along the outer circumference of the rotary drum.

3. The liquid ejecting apparatus according to claim 2, wherein the removal unit removes the solidified liquid by coming into contact with the wiping member.

4. The liquid ejecting apparatus according to claim 1, wherein the irradiation unit is also capable of solidifying the liquid ejected from the ejection head onto the recording medium.

5. The liquid ejecting apparatus according to claim 2, wherein the solidified liquid adheres to both faces of the wiping member and is removed by the removal unit by the rotary drum rotating in both a forward and reverse direction in order to remove the solidified liquid adhered to both faces of the wiping member.

6. The liquid ejecting apparatus according to claim 2, wherein the wiping member engages the ejection head and does not engage the irradiation unit by changing the protrusion height of the wiping member.

7. The liquid ejecting apparatus according to claim 2, wherein the wiping member is capable of extending from and retracting into the outer circumference of the rotary drum, such that the wiping member is extended from the outer circumference of the rotary drum when the wiping member wipes the nozzle forming surface, and such that the solidified ink adhering to the wiping member is removed when the wiping member is retracted into the outer circumference of the rotary drum.

8. The liquid ejecting apparatus according to claim 2,
wherein the wiping member is configured to be engaged with both the ejection head and the irradiation unit by varying the protrusion height of the wiping member,
wherein a distance between the ejection head and the outer circumference of the rotary drum and a distance between the irradiation unit and the outer circumference of the rotary drum are different from each other,
wherein, when the wiping member is engaged with the ejection head, the protrusion height becomes a height corresponding to the distance between the ejection head and the outer circumference of the rotary drum, and
wherein, when the wiping member is engaged with the irradiation unit, the protrusion height becomes a height corresponding to the distance between the irradiation unit and the outer circumference of the rotary drum.

9. A liquid ejecting apparatus comprising:
a rotary drum that is capable of rotating about a shaft center and holding a recording medium held on an outer circumference of the rotary drum;
an ejection head disposed along the outer circumference of the rotary drum capable of ejecting liquid toward the recording medium that may be cured by irradiation of an energy ray;
a wiping member disposed in a space between the ends of the recording medium held by the rotary drum that is capable of wiping a nozzle forming face of the ejection head;
an irradiation unit disposed along the outer circumference of the rotary drum that is capable of curing and solidifying the liquid adhering to the wiping member by irradiating the energy ray after the nozzle forming face is wiped by the wiping member and capable of solidifying the liquid ejected toward the recording medium; and
a removal unit that disposed along the outer circumference of the rotary drum removes the solidified liquid from the wiping member.

10. The liquid ejecting apparatus according to claim 9, wherein the removal unit removes the solidified liquid by coming into contact with the wiping member.

11. The liquid ejecting apparatus according to claim 9, wherein the solidified liquid adheres to both faces of the wiping member and is removed by the removal unit by the rotary drum rotating in both a forward and reverse direction in order to remove the solidified liquid adhered to both faces of the wiping member.

12. The liquid ejecting apparatus according to claim 9, wherein the wiping member engages the ejection head and does not engage the irradiation unit by changing the protrusion height of the wiping member.

13. The liquid ejecting apparatus according to claim 9, wherein the wiping member is capable of extending from and retracting into the outer circumference of the rotary drum, such that the wiping member is extended from the outer circumference of the rotary drum when the wiping member wipes the nozzle forming surface, and such that the solidified ink adhering to the wiping member is removed when the wiping member is retracted into the outer circumference of the rotary drum.

14. The liquid ejecting apparatus according to claim 9,
wherein the wiping member is configured to be engaged with both the ejection head and the irradiation unit by varying the protrusion height of the wiping member,
wherein a distance between the ejection head and the outer circumference of the rotary drum and a distance between the irradiation unit and the outer circumference of the rotary drum are different from each other,
wherein, when the wiping member is engaged with the ejection head, the protrusion height becomes a height corresponding to the distance between the ejection head and the outer circumference of the rotary drum, and
wherein, when the wiping member is engaged with the irradiation unit, the protrusion height becomes a height corresponding to the distance between the irradiation unit and the outer circumference of the rotary drum.
